(19) United States
(12) Patent Application Publication
(10) Pub. No.: US 2017/0262091 A1
(43) Pub. Date: Sep. 14, 2017

(54) TOUCH APPARATUS AND TOUCH DISPLAY APPARATUS

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Qingpu WANG, Beijing (CN); Lei ZHANG, Beijing (CN); Jun LI, Beijing (CN); Wenjin FAN, Beijing (CN); Yuhui LAI, Beijing (CN)

(21) Appl. No.: 15/206,787

(22) Filed: Jul. 11, 2016

(30) Foreign Application Priority Data
Mar. 10, 2016 (CN) 201610136618.X

(51) Int. Cl. G06F 3/044

(52) U.S. Cl. CPC G06F 3/044

(57) ABSTRACT

The embodiments of the disclosure provide touch apparatus and touch display apparatus which can enhance the anti-ESD capacity. The touch apparatus comprises a touch area and a routing area surrounding the touch area. The apparatus further comprises first electrode line unit located in the routing area, wherein the first electrode line unit comprises first inducting electrode line group and first driving electrode line group, and the ends for connecting chip of the first inducting electrode line group and the ends for connecting chip of the first driving electrode line group are located in the same side of the touch area; first ground line located in the routing area, wherein the first ground line comprises first part, second part and first connecting part for electrically connecting the first part with the second part, wherein the first part is located between the first inducting electrode line group and the first driving electrode line group, the second part surrounds the touch area and is located in the outside of the first electrode line unit, two grounding terminals of the first ground line and the ends for connecting chip of the first inducting electrode line group and the ends for connecting chip of the first driving electrode line group are located in the same side of the touch area.

### CROSS-REFERENCE TO RELATED APPLICATION

This application claims benefit and priority to Chinese Patent Application No. 201610136618.X, filed Mar. 10, 2016. The entire disclosure of the above application is incorporated herein by reference.

### FIELD

The present disclosure relates to touch apparatus and touch display apparatus.

### BACKGROUND

This section provides background information related to the present disclosure which is not necessarily prior art.

The touch apparatus has become a widely used input device since the input can be implemented by finger touch on the touch apparatus which makes the man-machine interaction more direct and the touch apparatus has the characteristics of simple, faster, humanization or the like.

A small amount of electrostatic charge may not give rise to breakdown of electrodes due to larger capacitance of the touch apparatus. However, on the one hand, both the active stylus widely used in the touch apparatus and the rapidly developing capacitive fingerprint identification function require the size of pitch of the touch apparatus to be smaller and the resolution to be increased such that the capacitance of a unit of pitch is smaller and the anti-static electricity capacity is weakened; on the other hand, the size of the touch apparatus is bigger and bigger with the development of all-in-one machine and large size commercial whiteboards, which may lead to increase of probability of damage of the touch apparatus caused by the static electricity. Therefore, an improved solution of the touch apparatus is required.

### SUMMARY

This section provides a general summary of the disclosure, and is not a comprehensive disclosure of its full scope or all of its features.

The embodiments described herein provide touch apparatus and touch display apparatus. Comparing to the prior art, the touch apparatus may enhance the anti-electro-static discharge (ESD) capacity of driving electrode line group and inducing electrode line group and the touch apparatus.

In a first aspect, a touch apparatus is provided. The touch apparatus comprises a touch area and a routing area surrounding the touch area; the touch apparatus further comprising first electrode line unit located in the routing area, wherein the first electrode line unit comprises first inducting electrode line group and first driving electrode line group, and the ends for connecting chip of the first inducting electrode line group and the ends for connecting chip of the first driving electrode line group are located in the same side of the touch area;

first ground line located in the routing area, wherein the first ground line comprises first part, second part and first connecting part for electrically connecting the first part with the second part, wherein the first part is located between the first inducting electrode line group and the first driving electrode line group, the second part surrounds the touch area and is located in the outside of the first electrode line unit, two grounding terminals of the first ground line and the ends for connecting chip of the first inducting electrode line group and the ends for connecting chip of the first driving electrode line group are located in the same side of the touch area.

In an embodiment, the first inducting electrode line group, the first driving electrode line group, the first part and the second part are located in the same layer; the first connecting part is located in a layer which is different from the layer in which the first part and the second part are located.

In an embodiment, the touch apparatus further comprises first insulating layer located in the routing area, wherein the first insulating layer is arranged between the layer in which the first part and the second part are located and the layer in which the first connecting part is located, and the first connecting part electrically connects the first part with the second part by a via hole of the first insulating layer.

In an embodiment, the touch apparatus further comprises a second electrode line unit located in the routing area, wherein the second electrode line unit comprises second driving electrode line group, and the ends for connecting chip of the second driving electrode line group and the ends for connecting chip of the first inducing electrode line group are located in the same side of the touch area; the first inducing electrode line group is located between the first driving electrode line group and the second driving electrode line group;

the second part of the first ground line comprises first sub-part, second sub-part and second connecting part for electrically connecting the first sub-part with the second sub-part, the first sub-part surrounding the touch area, the second sub-part located between the second driving electrode line group and the first inducing electrode line group.

In an embodiment, the second driving electrode line group, the first inducing electrode line group, the first driving electrode line group, the first sub-part and the second sub-part are located in the same layer; the second connecting part is located in a layer which is different from the layer in which the first sub-part and the second sub-part are located.

In an embodiment, the touch apparatus further comprises second insulating layer located in the routing area, wherein the second insulating layer is arranged between the layer in which the first sub-part and the second sub-part are located and the layer in which the second connecting part is located, and the second connecting part electrically connects the first sub-part with the second sub-part by a via hole of the second insulating layer.

In an embodiment, the touch apparatus further comprises a light blocking layer arranged at the routing area and located in the underneath of the routing area.

In an embodiment, the touch apparatus further comprises second ground line located in the routing area, wherein the second ground line surrounds the touch area and is located in the outside of the first electrode line unit, and two grounding terminals of the second ground line and two grounding terminals of the first ground line are located in the same side of the touch area.

In an embodiment, the touch apparatus further comprises a plurality of inducing electrodes and a plurality of driving electrodes which are located in the touch area, wherein the first inducing electrode line group is connected with the plurality of inducing electrodes, the first driving electrode line group is connected with the plurality of the driving electrodes.

In another aspect, a touch display apparatus is provided. The touch display apparatus comprises any of the touch apparatuses above.

The embodiments described herein provide the touch apparatus in which the first ground line is arranged, wherein, the first part of the first ground line is located between the first inducing electrode line group and the first driving electrode line group such that the static electricity of the first inducing electrode line group and the first driving electrode line group at both sides of the first part can be exported. In addition, the second part of the first ground line is electrically connected with the first part by the first connecting part such that the static electricity of the first part can be exported to the second part. In other words, the static electricity of the first inducing electrode line group and the first driving electrode line group can move toward two directions and be exported from two grounding terminals respectively. Therefore, comparing to the prior art in which the static electricity of the first inducing electrode can only move toward one direction and be exported from one grounding terminal, the embodiments of the disclosure enhance the anti-ESD capacity of the first inducing electrode line group, and then enhance the anti-ESD capacity of the touch apparatus.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure

### DRAWINGS

The drawings described herein are for illustrative purposes only of selected embodiments and not all possible implementations, and are not intended to limit the scope of the present disclosure.

FIG. 1 schematically shows the structure of a touch apparatus;

FIG. 2 schematically shows an enlarged diagram of a point D in FIG. 1;

FIG. 3 schematically shows the structure of the touch apparatus according to an embodiment of the present invention;

FIG. 4 schematically shows a section view along a direction AA′ in FIG. 3;

FIG. 5 schematically shows the structure of the touch apparatus according to another embodiment of the present invention;

FIG. 6 schematically shows a section view of along a direction BB′ in FIG. 5;

FIG. 7 schematically shows first section view along a direction CC′ in FIG. 5;

FIG. 8 schematically shows second section view along a direction CC′ in FIG. 5;

FIG. 9 schematically shows the structure of the touch apparatus according to another embodiment of the present invention;

FIG. 10 schematically shows the structure of the touch apparatus according to another embodiment of the present invention; and

FIG. 11 schematically shows the structure of the touch apparatus according to another embodiment of the present invention.

### EXPLANATION OF REFERENCE NUMERALS

01—touch area; 02—routing area; 10—first electrode line unit; 101—first inducing electrode line group; 101a—ends for connecting chip of the first inducing electrode line group; 1011—inducing electrode; 102—first driving electrode line group; 102a—ends for connecting chip of the first driving electrode line group; 1021—driving electrode; 1022—protective layer; 20—first ground line; 20a—grounding terminal of the first ground line; 201—first part; 202—second part; 202a—first sub-part; 202b—second sub-part; 202c—second connecting part; 30—first insulating layer; 40—second electrode line unit; 401—second driving electrode line group; 401a—ends for connecting chip of the second driving electrode line group; 50—second insulating layer; 60—light blocking layer; 70—second ground line; 70a—grounding terminal of the second ground line. Corresponding reference numerals indicate corresponding parts or features throughout the several views of the drawings.

### DETAILED DESCRIPTION

Example embodiments will now be described more fully with reference to the accompanying drawings.

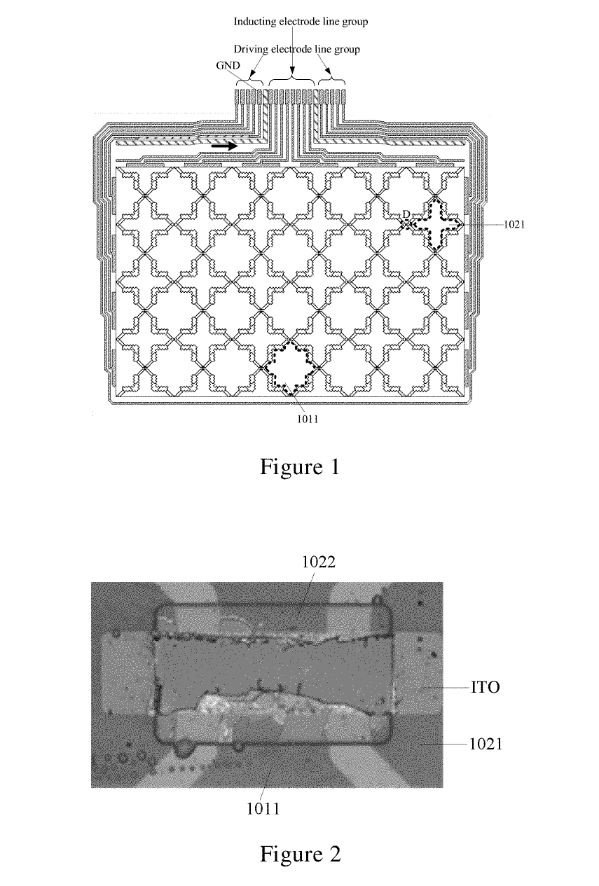

As shown in FIG. 1, the touch apparatus comprises driving electrodes TX1021 and inducing electrodes Rx1011. Take FIG. 1 as an example, the connecting points arranged in a layer in which the inducing electrodes Rx1011 are located are used to connect the inducing electrodes Rx1011, the connecting lines (for example, the ITO (indium tin oxides) connecting line as shown in a point D of FIG. 1) arranged in a layer in which the driving electrodes Tx1021 are not located are used to connect the driving electrodes Tx1021, and a protective layer is arranged between the layer in which the driving electrodes Tx1021 are located and the layer in which the connecting lines or ITO are located. Wherein, poor ESD may lead to breakdown along the direction of the driving electrode Tx1021 as shown in FIG. 2, which may result in burn and separation of the protective layer 1022 and/or ITO such that the normal connection between the driving electrodes Tx1021 is break or the inducing electrodes Rx1011 and the driving electrode Tx1021 contact which may give rise to undesirable touch apparatus.

In the prior art, at present, for most common touch apparatuses with 2T1R design as shown in FIG. 1, a GND line is arranged between the driving electrode line group and the inducing electrode line group to export the static electricity of the driving electrode line group and the inducing electrode line group, thereby solving the problem of poor ESD. However, the static electricity of the driving electrode line group and the inducing electrode line group can only be discharged at one end (grounding terminal) of the GND line in the prior art, its ESD capacity therefore is weak.

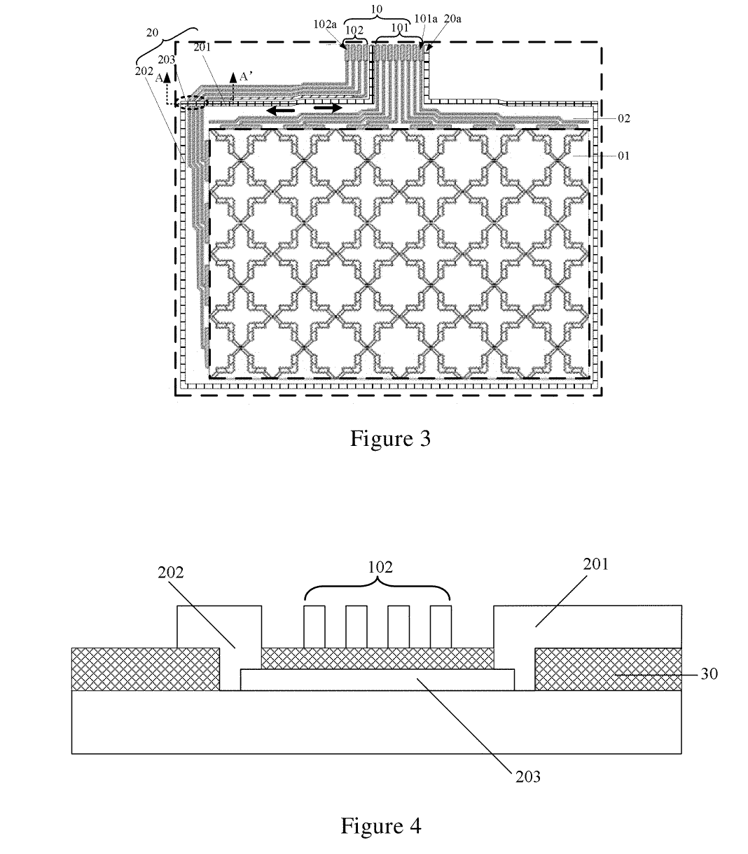

The embodiments of the present disclosure can solve or mitigate at least one of the above problems. FIG. 3 schematically shows the structure of the touch apparatus according to an embodiment of the present invention. The touch apparatus comprises a touch area 01 and a routing area 02 surrounding the touch area 01, as shown in FIG. 3.

The touch apparatus comprises first electrode line unit located in the routing area 02, wherein the first electrode line unit 10 comprises first inducting electrode line group 101 and first driving electrode line group 102, and the ends 101a for connecting chip of the first inducting electrode line group 101 and the ends 102 for connecting chip of the first driving electrode line group 102 are located in the same side of the touch area 01 (for example, in the upper side of the touch area 01).

The touch apparatus further comprises first ground line 20 located in the routing area 02, wherein the first ground line 20 comprises first part 201, second part 202 and first connecting part 203 (as shown by the dotted circle in FIG. 3) for electrically connecting the first part 201 with the second part 202, wherein the first part 201 is located between the first inducting electrode line group 101 and the first driving electrode line group 102, the second part 202 surrounds the touch area 01 and is located in the outside of the first electrode line unit 10, two grounding terminals 20a of the first ground line 20 and the ends 101a for connecting chip of the first inducting electrode line group 101 and the ends 102a for connecting chip of the first driving electrode line group 102 are located in the same side of the touch area 01.

It is noted that the number of inducing electrode lines in the first inducing electrode line group 101 and the number of the driving electrode lines in the first driving electrode line group 102 are not restricted. Wherein the first inducing electrode line group 101 and the first driving electrode line group 102 can be routed and connected by reference to the prior art. By way of example, the first inducing electrode line group 101 is connected with the inducing electrodes within the touch area 01, and the first driving electrode line group 102 is connected with the driving electrodes within the touch area 01. The specific structures or shapes of the inducing electrodes and the driving electrodes are restricted in the embodiments of the present invention, and the Figures are only as examples.

In this embodiment, the static electricity of the first inducing electrode line group 101 is exported, i.e., the static electricity of the inducing electrodes is exported, since the first inducing electrode line group 101 is connected with the inducing electrodes. The static electricity of the first driving electrode line group 102 is exported, i.e., the static electricity of the driving electrodes is exported, since the first driving electrode line group 102 is connected with the driving electrodes.

It is noted that the materials of the first connecting part 203 may comprise any suitable materials that enable the first part 201 to be electrically connected with the second part 202. For example, the materials of the first connecting part 203 may be same/different as/from that of the first part 201 and the second part 202, As an example, the materials of the first connecting part 203 can for example be ITO, IZO (Indium Zinc Oxide) or the like.

In addition, the way of how the first connecting part 203 electrically connecting the first part 201 with the second part 202 is not restricted only if the first connecting part 203 can electrically connect the first part 201 with the second part 202. By way of example, the first connecting part 203 may be a connecting wire, a transistor or the like, and it is a wire in this embodiment.

In an embodiment, first ground line 20 is arranged in the touch apparatus, wherein first part 201 of the first ground line 20 is located between the first inducing electrode line group 101 and the first driving electrode line group 102 such that the static electricity of the first inducing electrode line group 101 and the first driving electrode line group 102 on either side of the first part 201 can be exported. In addition, the second part 202 of the first ground line 20 is electrically connected with the first part 201 by the first connecting part 203, such that the static electricity of the first part 201 can also be exported to the second part 202, and the static electricity of the first inducing electrode line group 101 and the first driving electrode line group 102 can move toward two directions as shown by arrows in the FIG. 3 and be exported from two grounding terminals respectively. However, the static electricity of the first inducing electrode line group 101 can only move toward one direction and be exported from one grounding terminal, and the embodiments of the present disclosure therefore enhance anti-ESD capacity of the first inducing electrode line group 101 and then enhance anti-ESD capacity of the touch apparatus.

In an embodiment, the first inducting electrode line group 101, the first driving electrode line group 102, the first part 201 and the second part 202 are located in the same layer; the first connecting part 203 is located in a layer which is different from the layer in which the first part 201 and the second part 202 are located.

In the manufacturing process of the touch apparatus, the first inducting electrode line group 101, the first driving electrode line group 102, the first part 201 and the second part 202 can be formed by one time pattern composition process, thereby simplifying the fabrication process of the touch apparatus.

In an embodiment, in order to guarantee that the first ground line 20 can export the static electricity of the first inducing electrode line group 101 better, the first part 201 and second part 202 of the first ground line 20 and the first inducing electrode line group 101 can be arranged in the same layer. Moreover, in order to prevent the first connecting part 203 and the first driving electrode line group 102 from being arranged in the same layer (which may cause the first connecting part 202 to partly overlap the first driving electrode line group 102), the first connecting part 203 and the first driving electrode line group 102 can be arranged in different layers, i.e., the first connecting part 203 can be arranged in a layer which is different from the layer in which the first part 201 and the second part 202 are located.

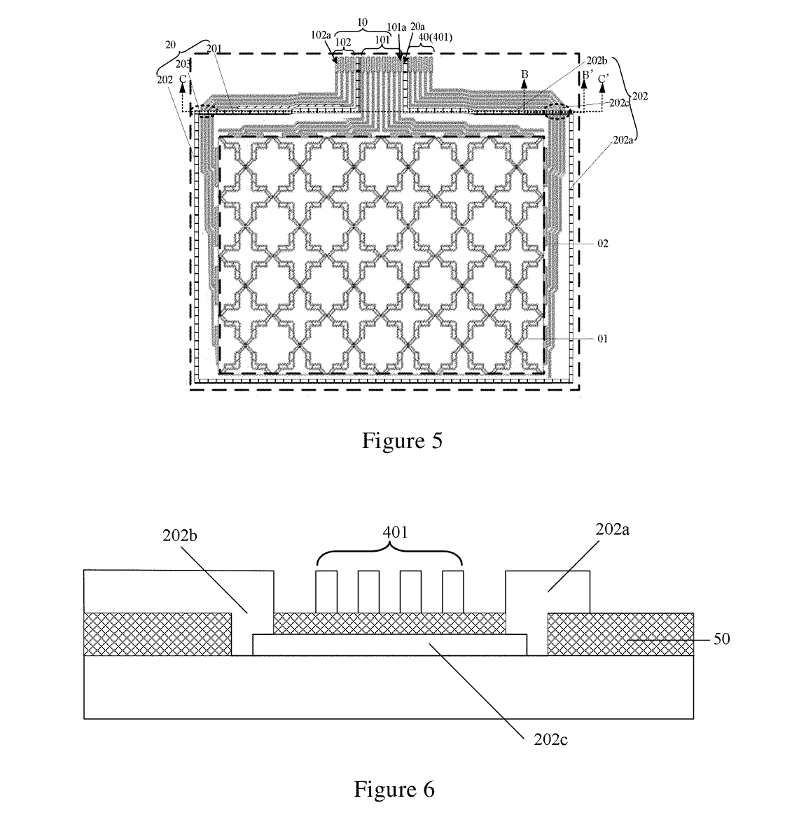

In an embodiment, as shown in FIG. 4, the touch apparatus further comprises first insulating layer 30 located in the routing area 02, and the first insulating layer 30 is arranged between the layer in which the first part 201 and the second part 202 are located and the layer in which the first connecting part 203 is located. The first connecting part 203 electrically connects the first part 201 with the second part 202 by a via hole of the first insulating layer 30.

It is noted that, the first connecting part 203 can be of any suitable shape (for example, line shape or curve shape or the like) only if it can electrically connect the first part 201 with the second part 202.

In this embodiment, the first connecting part 203 electrically connecting the first part 201 with the second part 202 by the via hole makes the fabrication process simple and easy to implement. In other embodiments, it can also adopt existing or future any suitable electric connect ways.

FIG. 5 schematically shows the structure of the touch apparatus according to another embodiment of the invention. The touch apparatus in FIG. 5 comprises some elements with the same reference number as that in FIG. 4. Since the functions and/or structures of these elements are same or similar, for some parts which have been described with respect to FIG. 4, the description of these parts is omitted here for brevity. As shown in FIG. 5, the touch apparatus further comprises a second electrode line unit 40 located in the routing area, wherein the second electrode line unit 40 comprises second driving electrode line group 401, and the ends 401a for connecting chip of the second driving electrode line group 401 and the ends 101a for connecting chip of the first inducing electrode line group 101 are located in the same side of the touch area; the first inducing electrode line group 101 is located between the first driving electrode line group 102 and the second driving electrode line group 401.

The second part 202 of the first ground line 20 comprises first sub-part 202a, second sub-part 202b and second connecting part 202c for connecting the first sub-part 202a with the second sub-part 202b. The first sub-part 202a surrounds the touch area 01, and the second sub-part 202b is located between the second driving electrode line group 401 and the first inducing electrode line group 101.

It is noted that the number of driving electrode lines in the second driving electrode line group 401 is not restricted, which may be correspondingly set according to the number of driving electrodes in the touch apparatus. Wherein each driving electrode may be connected with a driving electrode line in the first driving electrode line group 102 and be connected with a driving electrode line in the second driving electrode line group 401 respectively; or each driving electrode may be connected with a driving electrode line in the first driving electrode line group 102 or be connected with a driving electrode line in the second driving electrode line group 401.

It is also noted that the materials of the second connecting part 202c may be same/different as/from that of the first connecting part 203.

The way of how the second connecting part 202c eclectically connecting the first sub-part 202a with the second sub-part 202b is not restricted only if the second connecting part 202c can electrically connect the first sub-part 202a with the second sub-part 202b. By way of example, the second connecting part 202c may be a connecting wire, a transistor or the like, and it is a wire in this embodiment.

In this embodiment, the corresponding driving electrodes can be driven faster to realize batter touch functionality since the touch apparatus comprises two driving electrode line groups (the first driving electrode line group 102 and the second driving electrode line group 401).

In an embodiment, the second driving electrode line group 401, the first inducting electrode line group 101, the first driving electrode line group 102, the first sub-part 202a and the second sub-part 202b are located in the same layer; the second connecting part 202c is located in a layer which is different from the layer in which the first sub-part 202a and the second sub-part 202b are located.

In this case, in the manufacturing process of the touch apparatus, the second driving electrode line group 401, the first inducting electrode line group 101, the first driving electrode line group 102, the first sub-part 202a and the second sub-part 202b can be formed by one time pattern composition process, thereby simplifying the fabrication process of the touch apparatus.

In addition, the second connecting part 202c and the first connecting part 203 may be located in the same layer or different layers. When the second connecting part 202c and the first connecting part 203 are located in the same layer and the materials of the second connecting part 202c and the first connecting part 203 are same, the second connecting part 202c and the first connecting part 203 may be formed by one time pattern composition process.

In an embodiment, in order to guarantee that the first ground line 20 can export the static electricity of the first inducing electrode line group 101 better, the first part 201, the first sub-part 202a and the second sub-part 202b of the first ground line 20 and the first inducing electrode line group 101 can be arranged in the same layer. Moreover, in order to prevent the second connecting part 202c and the second driving electrode line group 401 from being arranged in the same layer (which may cause the second connecting part 202c to partly overlap the second driving electrode line group 401), the second connecting part 202c and the second driving electrode line group 401 can be arranged in different layers, i.e., the second connecting part is located in a layer which is different from the layer in which the first sub-part 202a and the second sub-part 202b are located.

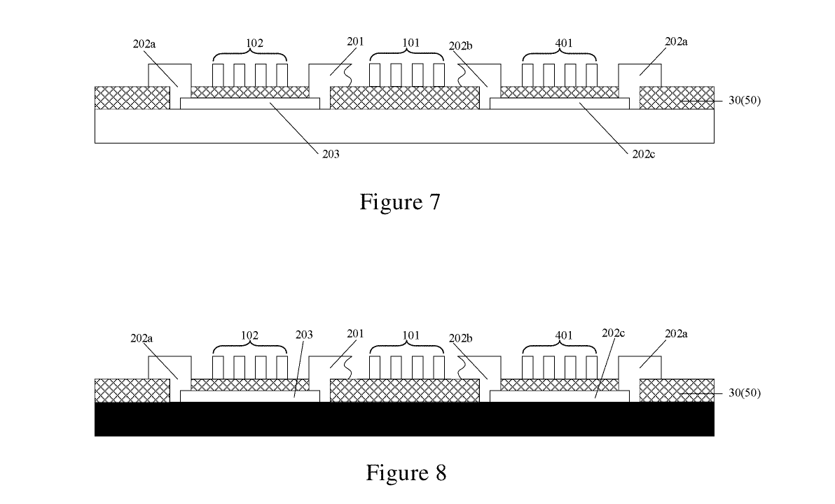

In an embodiment, as shown in FIGS. 6 and 7, the touch apparatus in FIG. 5 further comprises second insulating layer 50 located in the routing area 02, wherein the second insulating layer 50 is arranged between the layer in which the first sub-part 202a and the second sub-part 202b are located and the layer in which the second connecting part 202c is located, and the second connecting part 202c electrically connects the first sub-part 202a with the second sub-part 202b by a via hole of the second insulating layer.

It is noted that, the second connecting part 202c can be of any suitable shape (for example, line shape or curve shape or the like) only if it can electrically connect the first sub-part 202a with the second sub-part 202b.

It is noted that the second insulating layer 50 and the first insulating layer 30 can be arranged in the same layer or different layers. When the second insulating layer 50 and the first insulating layer 30 are arranged in the same layer, they may be formed by one time pattern composition process.

In this embodiment, the second connecting part 202c electrically connecting the first sub-part 202a with the second sub-part 202b by the via hole makes the structure simple and easy to implement. In other embodiments, it can also adopt existing or future any suitable electric connect ways.

In an embodiment, as shown in FIG. 8, the touch apparatus further comprises a light blocking layer 60 arranged at the routing area 02 and located in the underneath of the routing area 02.

In this embodiment, the materials of the light blocking layer 60 are not restricted only if it can block the light. For example, the materials of the light blocking layer 60 may be a resinous polymer.

In this embodiment, the light blocking layer 60 is located in the underneath of the routing area 02 in order to prevent light leak.

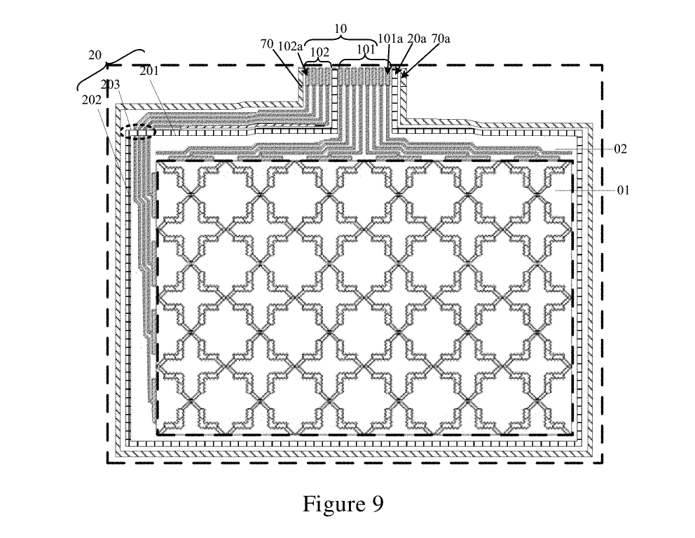

FIGS. 9-11 schematically show the structures of the touch apparatuses according to various embodiments of the present invention. The touch apparatus in FIGS. 9-11 comprises some elements with the same reference number as that in FIG. 4 and/or FIG. 5. Since the functions and/or structures of these elements are same or similar, for some parts which have been described with respect to FIG. 4 and/or FIG. 5, the description of these parts is omitted here for brevity. As shown in FIGS. 9-11, the touch apparatus further comprises second ground line 70 located in the routing area 02, wherein the second ground line 70 surrounds the touch area 01 and is located in the outside of the first electrode line unit 10. Two grounding terminals 70a of the second ground line 70 and two grounding terminals 20a of the first ground line 20 are located in the same side of the touch area 01.

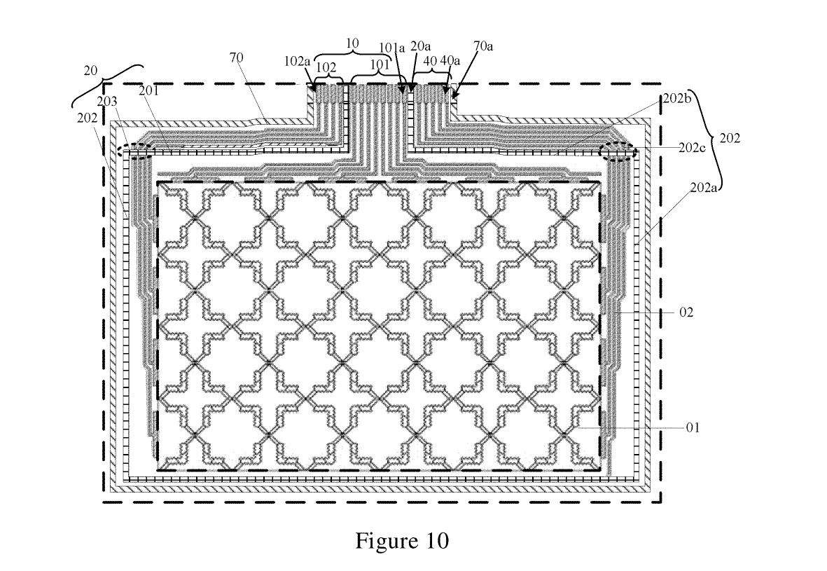

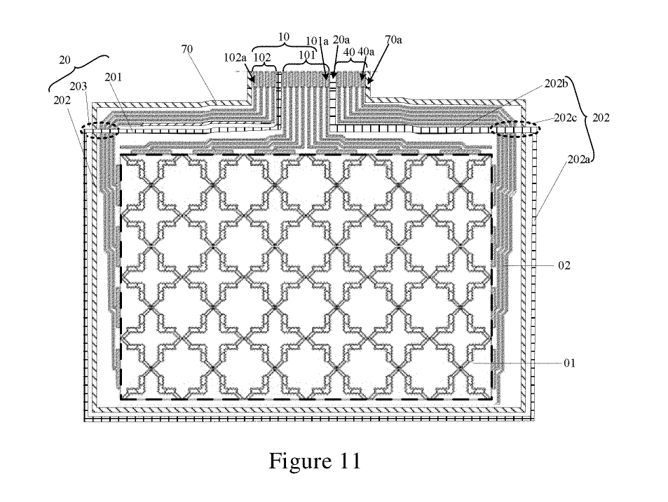

In an embodiment, as shown in FIG. 9 or 10, the second ground line 70 may be arranged in the outside of the first electrode line unit 10 and the first ground line 20. In another embodiment, as shown in FIG. 11, the first part 201 and the second sub-part 202b of the first ground line 20 are arranged in the inside of the second ground line 70, the first sub-part 202a is arranged in the outside of the second ground line 70, the first connecting part 203 crosswise overlaps the second ground line 70 and the first driving electrode line group 101, and the second connecting part 202c crosswise overlaps the second ground line 70 and the second driving electrode line group 401.

In addition, it is noted that direct neighbor parts in the first ground line and the second ground line can be integrated together in the embodiments as shown in FIGS. 9-11.

In the embodiments of the present invention, the second ground line 70 is arranged in the touch area 01, and the static electricity of the driving electrode line group can be exported from two grounding terminals of the second ground line 70. The static electricity of the first driving electrode line group 102 can be exported from the second ground line 70 when the touch apparatus only comprises the first driving electrode line group 102; the static electricity of the first driving electrode line group 102 and/or the second driving electrode line group 402 can be exported from the second ground line 70 when the touch apparatus comprises the first driving electrode line group 102 and the second driving electrode line group 402, thereby enhancing the anti-ESD capacity of the driving electrode line group and the touch apparatus and improving the quality of the touch apparatus.

In an embodiment, the touch apparatus further comprises a plurality of inducing electrodes and a plurality of driving electrodes which are located in the touch area 01, wherein, the first inducing electrode line group 101 is connected with the plurality of inducing electrodes, the first driving electrode line group 102 is connected with the plurality of the driving electrodes.

It is noted that the number of the inducing electrodes and the number of the driving electrodes are not restricted, which may be appropriately set according to the size of the touch area of the touch apparatus.

In the embodiments of the present invention, the combination of the plurality of inducing electrodes and the plurality of driving electrodes can implement the touch functionality.

A touch display apparatus is disclosed by embodiments of the present invention, which comprises the touch apparatus of any of above embodiments.

Note that the above mentioned touch display apparatus can be any product or component capable of displaying function, such as a liquid crystal display, an OLED (Organic Light-Emitting Diode) display, a television, a laptop, a digital photo frame, a mobile phone, a tablet, a navigator and so on.

In the touch apparatus according to the embodiments of the present invention, the embodiments of the disclosure enhance the anti-ESD capacity of the first inducing electrode line group 101, the first driving electrode line group 102 and the second driving electrode line group 401, enhance the anti-ESD capacity of the touch apparatus and the touch display apparatus, and improve the quality of the touch display apparatus, since two ends of the first ground line 20 can export the static electricity of the first inducing electrode line group 101, two ends of the second ground line 70 can export the static electricity of the first driving electrode line group 102 and/or the second driving electrode line group 401.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A touch apparatus comprising a touch area and a routing area surrounding the touch area; the touch apparatus further comprising
first electrode line unit located in the routing area, wherein the first electrode line unit comprises first inducting electrode line group and first driving electrode line group, and the ends for connecting chip of the first inducting electrode line group and the ends for connecting chip of the first driving electrode line group are located in the same side of the touch area;
first ground line located in the routing area, wherein the first ground line comprises first part, second part and first connecting part for electrically connecting the first part with the second part, wherein the first part is located between the first inducting electrode line group and the first driving electrode line group, the second part surrounds the touch area and is located in the outside of the first electrode line unit, two grounding terminals of the first ground line and the ends for connecting chip of the first inducting electrode line group and the ends for connecting chip of the first driving electrode line group are located in the same side of the touch area.

2. The touch apparatus according to claim 1, wherein the first inducting electrode line group, the first driving electrode line group, the first part and the second part are located in the same layer; the first connecting part is located in a layer which is different from the layer in which the first part and the second part are located.

3. The touch apparatus according to claim 2, wherein the touch apparatus further comprises first insulating layer located in the routing area, wherein the first insulating layer is arranged between the layer in which the first part and the second part are located and the layer in which the first connecting part is located, and the first connecting part electrically connects the first part with the second part by a via hole of the first insulating layer.

4. The touch apparatus according to claim 1, wherein the touch apparatus further comprises a second electrode line unit located in the routing area, wherein the second electrode line unit comprises second driving electrode line group, and the ends for connecting chip of the second driving electrode line group and the ends for connecting chip of the first inducing electrode line group are located in the same side of the touch area; the first inducing electrode line group is located between the first driving electrode line group and the second driving electrode line group;
the second part of the first ground line comprises first sub-part, second sub-part and second connecting part for electrically connecting the first sub-part with the second sub-part, the first sub-part surrounding the touch area, the second sub-part located between the second driving electrode line group and the first inducing electrode line group.

5. The touch apparatus according to claim 4, wherein the second driving electrode line group, the first inducing electrode line group, the first driving electrode line group, the first sub-part and the second sub-part are located in the same layer; the second connecting part is located in a layer which is different from the layer in which the first sub-part and the second sub-part are located.

6. The touch apparatus according to claim 5, wherein the touch apparatus further comprises second insulating layer located in the routing area, wherein the second insulating layer is arranged between the layer in which the first sub-part and the second sub-part are located and the layer in which the second connecting part is located, and the second connecting part electrically connects the first sub-part with the second sub-part by a via hole of the second insulating layer.

7. The touch apparatus according to claim 1, wherein the touch apparatus further comprises a light blocking layer arranged at the routing area and located in the underneath of the routing area.

8. The touch apparatus according to claim 1, wherein the touch apparatus further comprises second ground line located in the routing area, wherein the second ground line surrounds the touch area and is located in the outside of the first electrode line unit, and two grounding terminals of the second ground line and two grounding terminals of the first ground line are located in the same side of the touch area.

9. The touch apparatus according to claim 4, wherein the touch apparatus further comprises second ground line located in the routing area, wherein the second ground line surrounds the touch area and is located in the outside of the first electrode line unit, and two grounding terminals of the second ground line and two grounding terminals of the first ground line are located in the same side of the touch area.

10. The touch apparatus according to claim 1, wherein the touch apparatus further comprises
a plurality of inducing electrodes and a plurality of driving electrodes which are located in the touch area, wherein, the first inducing electrode line group is connected with the plurality of inducing electrodes, the first driving electrode line group is connected with the plurality of the driving electrodes.

11. A touch display apparatus comprising the touch apparatus of the claim 1.

12. A touch display apparatus comprising the touch apparatus of the claim 2.

13. A touch display apparatus comprising the touch apparatus of the claim 3.

14. A touch display apparatus comprising the touch apparatus of the claim 4.

15. A touch display apparatus comprising the touch apparatus of the claim 5.

16. A touch display apparatus comprising the touch apparatus of the claim 6.

17. A touch display apparatus comprising the touch apparatus of the claim 7.

18. A touch display apparatus comprising the touch apparatus of the claim 8.

19. A touch display apparatus comprising the touch apparatus of the claim 9.

20. A touch display apparatus comprising the touch apparatus of the claim 10.
